(19) United States
(12) Patent Application Publication
(10) Pub. No.: US 2026/0010397 A1
(43) Pub. Date: Jan. 8, 2026

(54) PROCESSOR AND OPERATION CONTROL METHOD OF PROCESSOR

(71) Applicant: Fujitsu Limited, Kawasaki-shi (JP)

(72) Inventor: Tetsuya ODAJIMA, Kawasaki (JP)

(73) Assignee: Fujitsu Limited, Kawasaki-shi (JP)

(21) Appl. No.: 19/248,940

(22) Filed: Jun. 25, 2025

(30) Foreign Application Priority Data
Jul. 4, 2024 (JP) 2024-107977

(51) Int. Cl. G06F 9/48; G06F 9/38

(52) U.S. Cl. CPC G06F 9/4881; G06F 9/3851

(57) ABSTRACT

A processor includes execution circuits configured to execute computational instructions; a first instruction queue configured to hold the computational instructions; second instruction queues respectively provided corresponding to the execution circuits, the second instruction queues being configured to hold the computational instructions and issue the held computational instructions to the corresponding execution units; data buffers respectively provided corresponding to the execution circuits and configured to hold data used by the computational instructions; and a transfer control circuit configured to detect an address of a memory that holds data used by each of the computational instructions held in the first instruction queue, transfer, to a second instruction queue corresponding to one of the execution circuits, target computational instructions that use data at a same address, based on the detected address, and transfer the data at the same address to a data buffer corresponding to the one of the execution circuit.

### CROSS-REFERENCE TO RELATED APPLICATIONS

This application is based upon and claims the benefit of priority of the prior Japanese Patent Application No. 2024-107977, filed on Jul. 4, 2024, the entire contents of which are incorporated herein by reference.

### FIELD

The present disclosure relates to a processor and an operation control method of the processor.

### BACKGROUND

There is known a method for improving instruction execution efficiency by storing an instruction block that is highly likely to be reused in an instruction window based on a priority of the instruction block and the like, and suppressing fetching of a new instruction block from an instruction cache (see, for example, Patent Document 1).

There is known an instruction processing device configured to store history, such as input data, calculation result data, an access address, and the like when executing an instruction, and skip execution of the instruction that is the same as the instruction in the history and use the calculation result data in the history, thereby reducing the execution time of an instruction sequence (see, for example, Patent Document 2).

There is known a processor including a general cache configured to hold frequently used data and operation codes (opcodes), and a microcode cache configured to hold frequently used microcode instruction words. The microcode cache holds regularly used microcode words such that they can be used for each clock. In this type of processor, less frequently used data, opcodes, and microcode instruction words are exchanged by frequently used data, opcodes, and microcode instruction words (see, for example, Patent Document 3).

### RELATED ART DOCUMENTS

[Patent Document 1] U.S. Patent Application Publication No. 2016/0378502
[Patent Document 2] International Publication Pamphlet No. WO 1998/011484
[Patent Document 3] U.S. Pat. No. 5,574,883

### SUMMARY

According to one aspect of the embodiments, A processor includes a plurality of execution circuits configured to execute a plurality of computational instructions; a first instruction queue configured to hold the plurality of computational instructions; a plurality of second instruction queues respectively provided corresponding to the plurality of execution circuits, the plurality of second instruction queues being configured to hold the plurality of computational instructions transferred from the first instruction queue, and issue the plurality of computational instructions held in the second instruction queues to the corresponding execution units; a plurality of data buffers respectively provided corresponding to the plurality of execution circuits and configured to hold data to be used by the plurality of computational instructions; and a transfer control circuit configured to detect an address of a memory that holds data to be used by each of the plurality of computational instructions held in the first instruction queue, transfer, to a second instruction queue corresponding to one of the plurality of execution circuits among the plurality of second instruction queues, target computational instructions that use data at a same address among the plurality of computational instructions, based on the detected address, and transfer the data at the same address to a data buffer corresponding to the one of the plurality of execution circuits among the plurality of data buffers.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a processor in an embodiment;

FIG. 2 is a flowchart illustrating an example of operations of the processor in FIG. 1;

FIG. 3 is a flowchart illustrating an example of the operation of step S110 in FIG. 2;

FIG. 4 is a block diagram illustrating an example of a processor in another embodiment;

FIG. 5 is a block diagram illustrating an example of a processor in another embodiment;

FIG. 6 is a flowchart illustrating an example of operations of the processor in FIG. 5;

FIG. 7 is a flowchart illustrating an example of operations of the processor when a dynamic scheduling mechanism in FIG. 5 performs instruction exchange processing;

FIG. 8 is a block diagram illustrating an example of a processor in another embodiment; and

FIG. 9 is a flowchart illustrating an example of operations of the processor in FIG. 8.

### DESCRIPTION OF EMBODIMENTS

When there are multiple execution units configured to execute computational instructions and multiple data buffers respectively corresponding to the multiple execution units, it is preferable that data to be used by the computational instruction executed by the corresponding execution unit is transferred from the memory or the like to the data buffer. Additionally, there is a case where the data to be used by multiple types of computational instructions is shared data held in the same address area in the memory. In this case, from the viewpoint of data reusability, it is preferable that the multiple types of computational instructions are executed by the execution unit corresponding to the data buffer to which the shared data is transferred.

With respect to the above, when the computational instructions that use the shared data are respectively executed by multiple execution units, the shared data is transferred from the memory to each of multiple data buffers, and thus the data reusability is reduced. Additionally, the power when the shared data is transferred to the multiple data buffers increases in comparison with the power when the shared data is transferred to a single data buffer.

In a processor including multiple execution units and multiple data buffers configured to respectively hold data to be used by the multiple execution units, data reusability can be improved.

Embodiments will be described below with reference to the drawings.

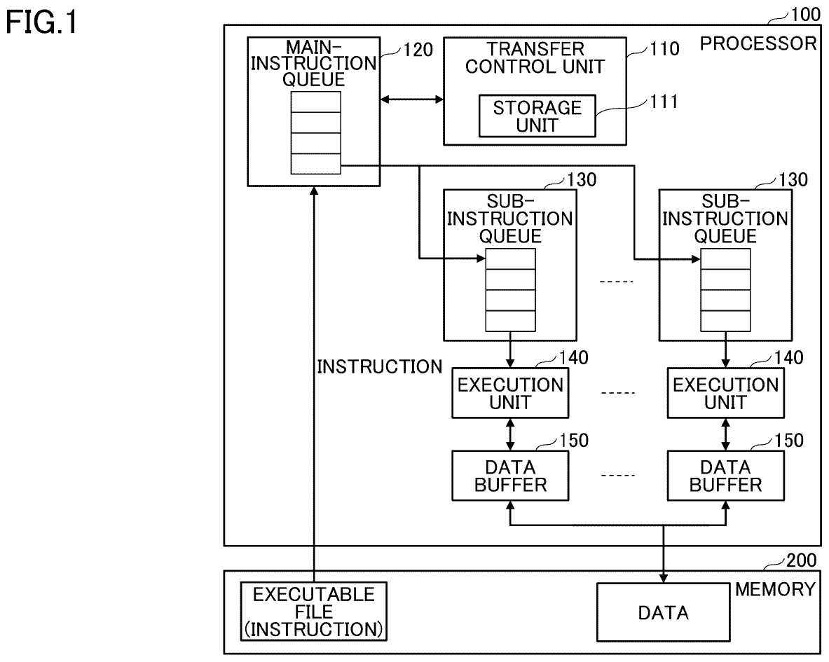

FIG. 1 illustrates an example of a processor in an embodiment. A processor 100 illustrated in FIG. 1 includes a transfer control unit 110 (i.e., a transfer control circuit 110) including a storage unit 111, a main-instruction queue 120, multiple sub-instruction queues 130, multiple execution units 140 (i.e., multiple execution circuits 140), and multiple data buffers 150, and is coupled to a memory 200. The main-instruction queue 120 is an example of a first instruction queue, and the sub-instruction queue 130 is an example of a second instruction queue. Although not particularly limited, for example, the processor 100 may be used for training or inference of image recognition in a neural network or the like, or may be used for scientific and technological calculations.

The sub-instruction queues 130 are provided corresponding to multiple execution units 140, respectively, and the data buffers 150 are provided corresponding to multiple execution units 140, respectively. The memory 200 includes an area for storing an executable file including an instruction to be executed by the execution unit 140 and data used by the instruction. The executable file is an object program obtained by compiling a source program.

For example, the instructions included in the executable file include a computational instruction, a data transfer instruction, and the like. The main-instruction queue 120 is configured to hold computational instructions and data transfer instructions. Although not particularly limited, the data transfer instruction is issued from the main-instruction queue 120 to a data transfer unit (i.e., a data transfer circuit), which is not illustrated in FIG. 1, via the sub-instruction queue 130. The data transfer unit that receives the data transfer instruction transfers data from the memory 200 to the data buffer 150 or transfers data from the data buffer 150 to the memory 200. The transfer control unit 110 performs processing of determining the sub-instruction queue 130 to which the computational instruction is transferred from the main-instruction queue 120 and processing of determining the data buffer 150 into which the data to be used by the computational instruction is stored.

The main-instruction queue 120 includes multiple entries for respectively holding multiple instructions in the executable file held in the memory 200. For example, the instructions held in the main-instruction queue 120 are transferred out-of-order to one of the sub-instruction queues 130 in the order in which the instructions can be executed regardless of the program description order.

For example, the data used by the multiple execution units 140 in the computational instructions are not dependent on each other. Thus, the computational instruction transferred out-of-order from the main-instruction queue 120 to the sub-instruction queue 130 and executed by the execution unit 140 may be completed out-of-order. Here, when the multiple execution units 140 might execute the computational instructions that use data dependent on each other, the computational instructions executed out-of-order by the execution units 140 may be completed in-order (in the program description order) by a commit control unit, which is not illustrated.

The sub-instruction queue 130 includes multiple entries holding computational instructions transferred from the main-instruction queue 120, and operates as first-in first-out (FIFO). The sub-instruction queue 130 sequentially issues computational instructions to the corresponding execution units 140.

The execution unit 140 reads the data to be used by the computational instruction received from the sub-instruction queue 130 from the data buffer 150, and performs computation using the read data. The computation result may be stored in the data buffer 150. Here, the processor 100 may include multiple types of execution units for respective types of computational instructions as the execution units 140 illustrated in FIG. 1. Additionally, the processor 100 may include the execution unit 140 configured to execute single instruction multiple data (SIMD) computational instructions.

The data buffer 150 holds the data read from the memory 200 by the data transfer instruction, and outputs the held data to the execution unit 140. Additionally, the data buffer 150 holds the computation result obtained by the execution unit 140 and outputs the held data to the execution unit 140 or the memory 200.

With respect to part or all of the computational instructions held in the main-instruction queue 120, based on the address held in the storage unit 111, the transfer control unit 110 determines which of the sub-instruction queues 130 to transfer the computational instruction to. When the transfer of the computational instruction is determined, the transfer control unit 110 notifies the main-instruction queue 120 of the sub-instruction queue 130 to which the computational instruction is to be transferred, for each of the computational instructions. That is, the transfer control unit 110 causes the computational instruction to be transferred to one of the sub-instruction queues 130 corresponding to the multiple execution units 140.

When receiving the notification from the transfer control unit 110, the main-instruction queue 120 transfers the computational instruction to the notified sub-instruction queue 130. When receiving no notification from the transfer control unit 110, the main-instruction queue 120 transfers the computational instruction to one of the sub-instruction queues 130. For example, the main-instruction queue 120 transfers, to the sub-instruction queue 130 having many empty entries, a computational instruction for which the notification is not provided from the transfer control unit 110. Alternatively, the main-instruction queue 120 transfers the computational instructions sequentially to the multiple sub-instruction queues 130 using a technique, such as round robin.

For example, if the processor is configured to execute SIMD computational instructions and single instruction single data (SISD) computational instructions, the transfer control unit 110 may determine which of the sub-instruction queues 130 to transfer the SIMD computational instruction to. In this case, the sub-instruction queue 130 that stores the SISD computational instruction may be determined by the main-instruction queue 120.

The transfer control unit 110 detects the address of the memory 200 where the data to be used by each of the multiple computational instructions held in the main-instruction queue 120 is stored. When the data used by the multiple computational instructions are included in the same address range, the transfer control unit 110 stores the address indicating the address range in the storage unit 111.

For example, the address range is indicated by an address of head data and an address of tail data included in a data group transferred between the memory 200 and the data buffer 150 for each memory access request, and corresponds to the transfer size of the data. For example, the address indicating the address range is a head address. Multiple addresses included in the address range are treated as the same address.

Here, when the address of the data used by multiple computational instructions is the same, the transfer control unit 110 may store the address in the storage unit 111, instead of the address range. Furthermore, when the data used by the computational instructions have different sizes, the data size may be stored in the storage unit 111 together with the address. When the data used by the computational instructions executed by the execution unit 140 have the same size, the data size is not required to be stored in the storage unit 111.

When the data used by the computational instructions have different sizes, it is determined whether the data to be used for the computation have the same address, by including the data size. For example, in order to determine whether the data of 4 bytes and the data of 16 bytes have the same address, it is determined whether the address of the data of 4 bytes is included in the address range of the data of 16 bytes by using the data size, instead of comparing the head addresses.

An example in which the transfer control unit 110 determines whether the data used by multiple computational instructions are included in the same address range will be described below. However, the transfer control unit 110 may determine whether the data used by multiple computational instructions have the same address.

The transfer control unit 110 detects whether the address of the data used by the computational instruction executed by the execution unit 140 is included in the address range stored in the storage unit 111. If the addresses of the data used by the multiple computational instructions are included in the same address range, the transfer control unit 110 determines the sub-instruction queue 130 to which the computational instruction is transferred and the data buffer 150 into which the data is stored such that the data used by the computational instruction is held in the data buffer 150 corresponding to the execution unit 140. That is, the transfer control unit 110 performs control to transfer multiple computational instructions that use the data in the same address range to the sub-instruction queue 130 corresponding to one of the execution units 140 and to transfer the data in the same address range to the data buffer 150 corresponding to the one of the execution units 140.

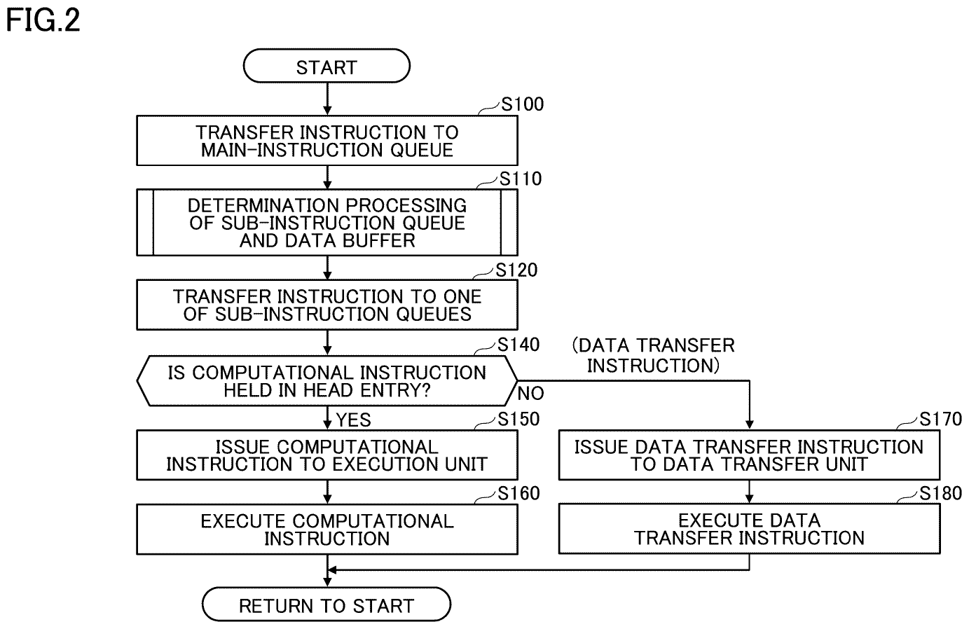

FIG. 2 illustrates an example of operations of the processor 100 illustrated in FIG. 1. That is, FIG. 2 illustrates an example of an operation control method of the processor 100. For example, a flow illustrated in FIG. 2 starts when the processor 100 executes an executable file, such as a user program.

First, in step S100, the processor 100 transfers an instruction included in the executable file held in the memory 200 to the main-instruction queue 120. The instruction transfer may be performed by a control device configured to control the operation of the processor 100.

Next, in step S110, the transfer control unit 110 performs processing of determining the sub-instruction queue 130 to which the computational instruction is transferred and the data buffer 150 into which the data is stored. Here, if no computational instruction is held in the main-instruction queue 120, or if the processing of step S110 corresponding to the computational instruction held in the main-instruction queue 120 has already been completed, step S110 is omitted.

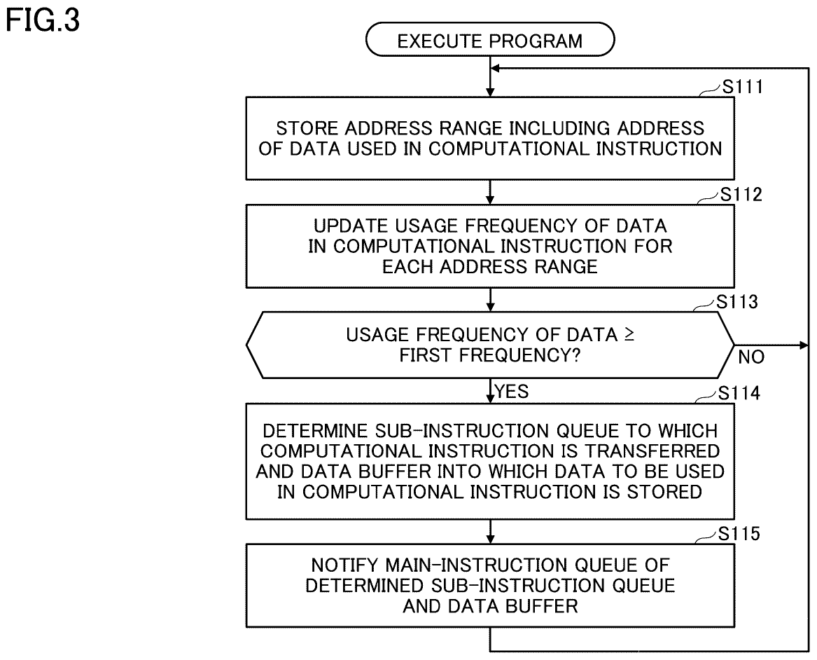

Here, step S110 may be performed at a frequency lower than the frequency of the instruction transfer to the main-instruction queue 120. In this case, the transfer control unit 110 performs the processing of step S110 for multiple computational instructions held in the main-instruction queue 120. An example of the operation of step S110 is illustrated in FIG. 3.

Next, in step S120, the main-instruction queue 120 transfers, to one of the sub-instruction queues 130, the instruction executable by the execution unit 140. The transfer control unit 110 outputs, to the main-instruction queue 120, the notification to transfer, to the sub-instruction queue 130, the computational instruction determined in step S110 among the computational instructions held in the main-instruction queue 120. When receiving the notification from the transfer control unit 110, the main-instruction queue 120 transfers the computational instruction to the notified sub-instruction queue 130.

The main-instruction queue 120 transfers, to one of the sub-instruction queues 130, the computational instruction for which the notification is not provided from the transfer control unit 110 or the data transfer instruction according to a rule such as round robin. Alternatively, the main-instruction queue 120 transfers, to the sub-instruction queue 130 that has many empty entries, the computational instruction for which the notification is not provided from the transfer control unit 110 or another instruction.

The processing from step S140 to step S180 is performed for each group of the sub-instruction queue 130, the execution unit 140, and the data buffer 150.

In step S140, the sub-instruction queue 130 determines whether the head entry holds the computational instruction. The sub-instruction queue 130 performs step S150 if the head entry holds the computational instruction, and performs step S170 if the head entry does not hold the computational instruction, that is, the data transfer instruction.

In step S150, the sub-instruction queue 130 issues the computational instruction held in the head entry to the execution unit 140. Next, in step S160, the execution unit 140 executes the computational instruction received from the sub-instruction queue 130.

In step S170, the sub-instruction queue 130 issues the data transfer instruction to the data transfer unit. Next, in step S180, the data transfer unit executes the data transfer instruction. After the completion of steps S160 and $180, the operation illustrated in FIG. 2 is repeatedly executed.

FIG. 3 illustrates an example of the operation of step S110 in FIG. 2. The operation illustrated in FIG. 3 is performed by the transfer control unit 110 in FIG. 1.

First, in step S111, for example, every time the computational instruction is stored in the main-instruction queue 120, the transfer control unit 110 stores, in the storage unit 111, an address range (for example, a head address) including the address of the data to be used by the stored computational instruction.

Next, in step S112, the transfer control unit 110 updates the usage frequency of the data used by the computational instruction for each of the address ranges stored in the storage unit 111. For example, the transfer control unit 110 updates the usage frequency of the data by incrementing a counter value indicating the frequency of the computational instruction for each of the address ranges and subtracting a constant value from the counter value every time a predetermined number of cycles have elapsed.

Here, by updating the usage frequency of the data for each of the address ranges that corresponds to the transfer size of the data from the memory 200, increase in the storage capacity of the storage unit 111 can be suppressed and complication of the control of the transfer control unit 110 can be reduced.

Next, in step S113, the transfer control unit 110 determines whether the usage frequency of the data used by the multiple computational instructions stored in the main-instruction queue 120 is greater than or equal to a first frequency. The transfer control unit 110 performs step S114 if the usage frequency of the data is greater than or equal to the first frequency, and returns to step S111 if the usage frequency of the data is less than the first frequency.

In step S114, the transfer control unit 110 determines the sub-instruction queue 130 to which the computational instruction is transferred and the data buffer 150 into which the data is stored. Next, in step S115, the transfer control unit 110 notifies the main-instruction queue 120 of the sub-instruction queue 130 and the data buffer 150 determined in step S114, and returns the operation to step S111.

The usage frequency of the data for each of the address ranges is less than the first frequency for a while from the start of program execution, and thus the sub-instruction queue 130 to which the computational instruction is transferred is determined by the main-instruction queue 120. In this case, multiple computational instructions that use the data in the same address range are not necessarily transferred to the same sub-instruction queue 130, and the data in the same address range may be transferred to multiple data buffers 150.

When the usage frequency of the data for each of the address ranges increases as the program execution proceeds, multiple computational instructions that use the data in the same address range are transferred to the same sub-instruction queue 130 more frequently. As a result, multiple computational instructions that use the data in the same address range are more likely to be transferred to the same sub-instruction queue 130, and the data in the same address range is more likely to be transferred to the same data buffer 150.

In the present embodiment, the computational instructions that use the data in the same address range and the data in the same address range are respectively transferred to the sub-instruction queue 130 and the data buffer 150 that correspond to one execution unit 140. With this, the transfer frequency of the data to be used by multiple computational instructions from the memory 200 to the data buffer 150 can be reduced, and the reusability of the data by multiple computational instructions that use the data held in the data buffer 150 can be improved. Here, the reusability of data increases as the data transferred to the data buffer 150 for use by one computational instruction is used by another computational instruction.

Furthermore, the transfer frequency of the data to be used by multiple computational instructions from the memory 200 to the data buffer 150 can be reduced, thereby reducing the power consumption of the processor 100.

Here, the data transfer instruction for transferring data from the memory 200 to the data buffer 150 is executed before the computational instruction that uses the transferred data. Therefore, the data read from the memory 200 by the data transfer instruction might not be stored in the data buffer 150 to which the data is to be transferred, determined by the transfer control unit 110 based on the address of the data to be used by the computational instruction.

In this case, the data to be used by the computational instruction is not transferred to the data buffer 150 corresponding to the sub-instruction queue 130 to which the computational instruction is transferred, and thus the computational instruction is aborted. After that, when the computational instruction is retried, in step S115, the sub-instruction queue 130 to which the computational instruction is transferred and the data buffer 150 to which the data used by the computational instruction is transferred are notified to the main-instruction queue 120. Then, the computational instruction and the data are respectively stored in the sub-instruction queue 130 and the data buffer 150 coupled to one execution unit 140.

In the embodiment illustrated in FIGS. 1 and 2, the transfer frequency of the data used by the multiple computational instructions from the memory 200 to the data buffer 150 can be reduced by operating the transfer control unit 110. With this, the reusability of the data held in the data buffer 150 by the multiple computational instructions can be improved, thereby reducing the power consumption of the processor 100.

When the usage frequency of the data used by the multiple computational instructions is greater than or equal to the first frequency, the transfer control unit 110 determines the sub-instruction queue 130 to which the computational instruction is transferred and the data buffer 150 into which the data is stored. It is not necessary to determine the data buffers 150 into which all the pieces of data are stored and the sub-instruction queues 130 to which the computational instructions that use the data are transferred, thereby reducing complication of the control of the transfer control unit 110.

By updating the usage frequency of the data for each of the address ranges that corresponds to the transfer size of the data from the memory 200, increase in the storage capacity of the storage unit 111 can be suppressed, thereby reducing complication of the control of the transfer control unit 110.

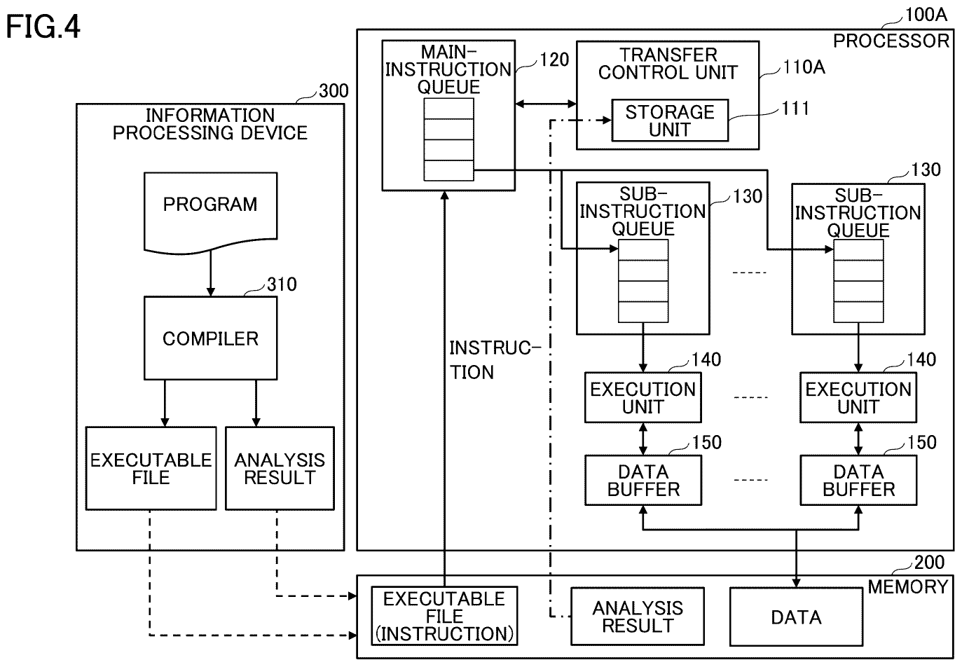

FIG. 4 illustrates an example of a processor according to another embodiment. Elements substantially the same as those in FIG. 1 are denoted by the same reference symbols, and detailed description thereof is omitted. A processor 100A illustrated in FIG. 3 has substantially the same configuration as the processor 100 illustrated in FIG. 1 except that a transfer control unit 110A is included instead of the transfer control unit 110 illustrated in FIG. 1. For example, the processor 100A may be used for training or inference of image recognition in a neural network or the like, or may be used for scientific and technological calculations.

The storage unit 111 of the transfer control unit 110A stores not only the address range determined by the transfer control unit 110A from the address of the data used by the computational instruction, but also an analysis result generated when the program executed by the processor 100A is compiled. A storage area for storing the analysis result in the storage unit 111 is an example of an analysis result storage unit.

For example, the analysis result includes an address of the data used by the computational instruction or an address range including the address of the data used by the computational instruction. The analysis result may include the usage frequency of the data used by multiple computational instructions for each of the address ranges. The analysis result may include the usage frequency of the data used by computational instructions for each of the addresses, not for each of the address ranges. When the usage frequency is for each of the addresses, the analysis result may include the size of data used by computational instructions. As described above, the analysis result may include information substantially the same as the information stored in the storage unit 111 by the transfer control unit 110A, as described with reference to FIGS. 1 to 3.

Then, the transfer control unit 110A uses not only the address range of the data used by computational instructions held in the main-instruction queue 120, but also the analysis result to determine the sub-instruction queue 130 to which the computational instruction is transferred and the data buffer 150 into which the data is stored.

The other functions of the transfer control unit 110A are substantially the same as those of the transfer control unit 110 in FIG. 1. The other components and functions of the processor 100A are substantially the same as those of the processor 100 in FIG. 1.

An information processing device 300 includes a compiler 310 configured to compile a program to be executed by the processor 100A. The compiler 310 generates an executable file that is executable by the processor 100A by compiling the program. When compiling the program, the compiler 310 analyzes the computational instructions included in the program and outputs the analysis result together with the executable file.

The range of the program to be analyzed by the compiler 310 may be the entire program or a range specified by the user who compiles the program with the compiler 310. For example, the user may specify a function written in the source program or a range of the source program, by using a compiler instruction, such as a pragma.

As indicated by the dashed arrow, the executable file and the analysis result generated by the compiler 310 are transferred to the memory 200 by an operating system (OS) executed by a computer, which is not illustrated, on which the processor 100A is mounted. The analysis result transferred to the memory 200 is further transferred to the storage unit 111 of the transfer control unit 110A as indicated by the dashed arrow. Here, the analysis result need not be stored in the storage unit 111. In this case, the transfer control unit 110A accesses the memory 200 to read the analysis result from the memory 200.

For example, the operation of the transfer control unit 110A is substantially the same as the flow illustrated in FIG. 3 except that the sub-instruction queue 130 to which the computational instruction is transferred and the data buffer 150 into which the data is stored are determined, including the address range included in the analysis result of the compiler 310. For example, in step S113 of FIG. 3, the transfer control unit 110A includes the usage frequency of the data included in the analysis result as the usage frequency of the data to be compared with the first frequency.

In step S113 of FIG. 3, the processor 100A of the present embodiment also uses the usage frequency of the data included in the analysis result to determine whether the usage frequency of the data used by the multiple computational instructions stored in the main-instruction queue 120 is greater than or equal to the first frequency. Thus, the sub-instruction queue 130 to which the computational instruction is transferred and the data buffer 150 into which the data is stored can be appropriately determined from the start of the program execution. Therefore, the reusability of the data held in the data buffer 150 by the multiple computational instructions can be improved from the start of the program execution.

As described above, substantially the same effect as the embodiment illustrated in FIGS. 1 to 3 can be obtained in the embodiment illustrated in FIG. 4. For example, the transfer frequency of the data used by multiple computational instructions from the memory 200 to the data buffer 150 can be reduced. With this, the reusability of the data held in the data buffer 150 by multiple computational instructions can be improved, thereby reducing the power consumption of the processor 100A.

Furthermore, in the embodiment illustrated in FIG. 4, the transfer control unit 110A compares the usage frequency of the data with the first frequency, by including the usage frequency of the data used by multiple computational instructions for each of the address ranges included in the analysis result generated by the compiler 310 when the program is compiled. Thus, the sub-instruction queue 130 to which the computational instruction is transferred and the data buffer 150 into which the data is stored can be appropriately determined from the start of the program execution. Therefore, the reusability of the data held in the data buffer 150 by multiple computational instructions can be improved from the start of the program execution.

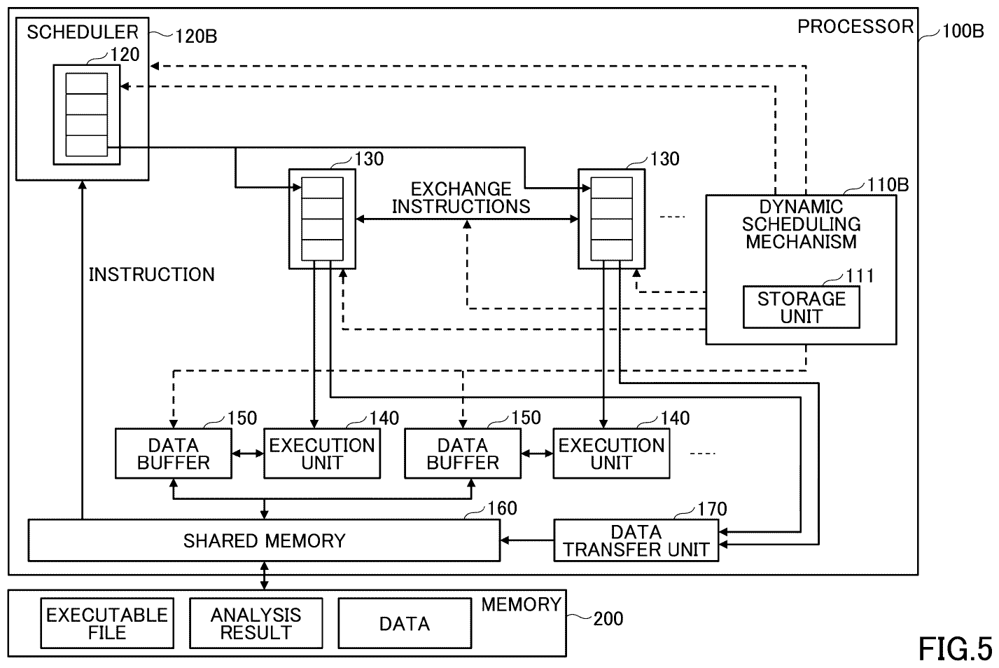

FIG. 5 illustrates an example of a processor in another embodiment. Elements substantially the same as those in FIG. 1 are denoted by the same reference symbols, and detailed description thereof is omitted. A processor 100B illustrated in FIG. 5 includes a dynamic scheduling mechanism 110B instead of the transfer control unit 110A illustrated in FIG. 4. Additionally, the processor 100B includes a scheduler 120B configured to manage an instruction output from the main-instruction queue 120, a shared memory 160, and a data transfer unit 170. The other components of the processor 100B are substantially the same as those of the processor 100A illustrated in FIG. 3. For example, the processor 100B may be used for training or inference of image recognition in a neural network or the like, or may be used for scientific and technological calculations.

As in the transfer control unit 110A illustrated in FIG. 4, the dynamic scheduling mechanism 110B includes the storage unit 111 configured to store the addresses of the data used by multiple computational instructions as the address ranges. The dynamic scheduling mechanism 110B is an example of a transfer control unit. Here, instead of the address range, the address of the data used by multiple computational instructions may be stored in the storage unit 111. Furthermore, when the execution unit 140 can execute computational instructions with different data sizes, the data sizes together with the addresses may be stored in the storage unit 111.

The dashed arrow extending from the dynamic scheduling mechanism 110B indicates that the dynamic scheduling mechanism 110B manages, controls, or monitors an element connected at the end of the arrow. For example, the dynamic scheduling mechanism 110B may monitor the address of the data used by the computational instruction held in the main-instruction queue 120. The dynamic scheduling mechanism 110B may monitor the address of the data used by the computational instruction held in the sub-instruction queue 130 and the address included in the data transfer instruction held in the sub-instruction queue 130. Additionally, the dynamic scheduling mechanism 110B may monitor the address of the data transferred to the data buffer 150. Then, the dynamic scheduling mechanism 110B notifies the scheduler 120B of the sub-instruction queue 130 to which the instruction is to be transferred.

The dynamic scheduling mechanism 110B may add, to the data transfer instruction for transferring the data from the memory 200 to the data buffer 150, transfer destination information indicating the data buffer 150 into which the data from the memory 200 is to be stored.

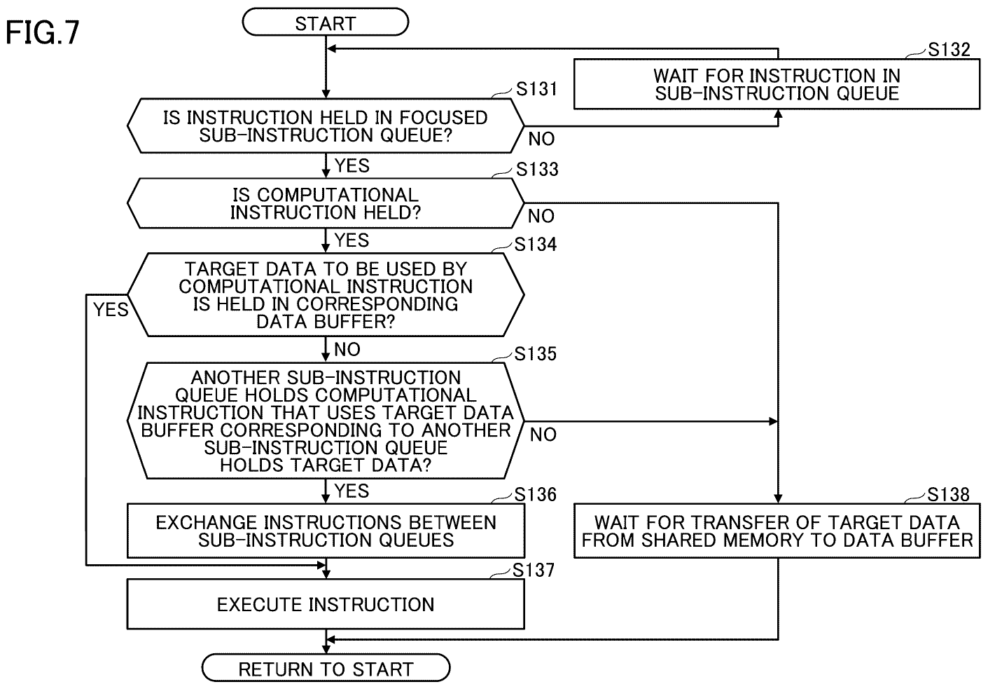

Furthermore, the dynamic scheduling mechanism 110B can perform the control of mutually exchanging the instructions held in the two sub-instruction queues 130. The instruction exchange control will be described with reference to FIG. 7. Here, the dynamic scheduling mechanism 110B may monitor the execution unit 140 or the data transfer unit 170. The operation of the dynamic scheduling mechanism 110B is substantially the same as that of the transfer control unit 110 illustrated in FIGS. 2 and 3 except that the instruction exchange control is performed between the sub-instruction queues 130.

The scheduler 120B transfers the instruction held in the main-instruction queue 120 to one of the sub-instruction queues 130 in the executable order. The basic operation of the scheduler 120B is to transfer the executable instruction to the sub-instruction queue 130 having an empty entry or to the sub-instruction queue 130 having many empty entries.

However, when the sub-instruction queue 130 to which the computational instruction is to be transferred is notified from the dynamic scheduling mechanism 110B, the scheduler 120B transfers the computational instruction held in the main-instruction queue 120 to the notified sub-instruction queue 130. Here, although the main-instruction queue 120 is included in the scheduler 120B in FIG. 5, the main-instruction queue 120 may be provided independently of the scheduler 120B.

The data transfer unit 170 controls data transfer between the memory 200 and the shared memory 160 based on the data transfer instruction issued from the sub-instruction queue 130, and controls data transfer between the shared memory 160 and each of the data buffers 150. For example, the data transfer unit 170 receiving a data transfer instruction to transfer data from the shared memory 160 to the data buffer 150 stores data read from the shared memory 160 in the data buffer 150 indicated by the transfer destination information added to the data transfer instruction. Here, the data transfer unit 170 may include a direct memory access controller (DMAC) configured to perform data transfer.

The shared memory 160 is a local memory, such as a scratchpad memory, for example. The shared memory 160 holds data before being transferred from the memory 200 to each of the data buffers 150, and holds data before being transferred from each of the data buffers 150 to the memory 200. Additionally, the shared memory 160 may hold the instructions held as the executable file in the memory 200, and transfer the held instructions to the main-instruction queue 120. Here, the processor 100B may include a data cache and an instruction cache, instead of the shared memory 160.

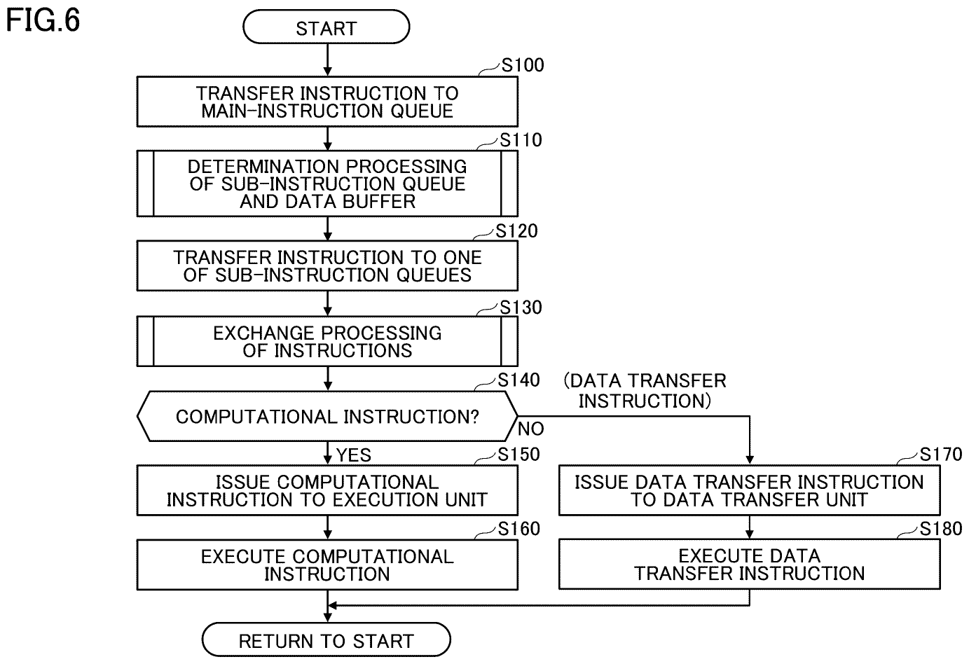

FIG. 6 illustrates an example of operations of the processor 100B illustrated in FIG. 5. That is, FIG. 6 illustrates an example of the operation control method of the processor 100B. Operations substantially the same as those illustrated in FIG. 2 are denoted by the same step numbers, and detailed description thereof is omitted. The operations of the processor 100B illustrated in FIG. 6 are substantially the same as those of FIG. 2 except that step S130 is performed between steps S120 and S140.

In step S130, the instructions held in the two sub-instruction queues 130 are exchanged by the dynamic scheduling mechanism 110B. An example of the operation of step S130 is illustrated in FIG. 7.

FIG. 7 illustrates an example of the operations of the processor 100B when the dynamic scheduling mechanism 110B of FIG. 5 performs the instruction exchange processing. That is, FIG. 7 illustrates an example of the operation control method of the processor 100B. To simplify the explanation, FIG. 7 illustrates an operation focusing on one of the sub-instruction queues 130. It is assumed that the sub-instruction queues 130 other than the focused sub-instruction queue 130 hold one or more instructions including a computational instruction.

First, in step S131, the dynamic scheduling mechanism 110B determines whether an instruction is held in the focused sub-instruction queue 130. The dynamic scheduling mechanism 110B performs step S133 if an instruction is held in the focused sub-instruction queue 130, and performs step S132 if no instruction is held in the focused sub-instruction queue 130.

In step S132, the dynamic scheduling mechanism 110B waits for an instruction to be held in the focused sub-instruction queue 130, and returns to step S131. In step S133, the dynamic scheduling mechanism 110B determines whether a computational instruction is held in the focused sub-instruction queue 130. The dynamic scheduling mechanism 110B performs step S134 if a computational instruction is held, and performs step S138 if no computational instruction is held.

In step S134, the dynamic scheduling mechanism 110B determines whether target data used by the computational instruction held in the focused sub-instruction queue 130 is held in the data buffer 150 corresponding to the focused sub-instruction queue 130. The dynamic scheduling mechanism 110B performs step S137 if the target data is held in the corresponding data buffer 150, and performs step S135 if the target data is not held in the corresponding data buffer 150.

In step S135, the dynamic scheduling mechanism 110B determines whether another sub-instruction queue 130 holds the computational instruction that uses the target data and whether the data buffer 150 corresponding to the other sub-instruction queue 130 holds the target data. The other sub-instruction queue 130 is a sub-instruction queue 130 different from the focused sub-instruction queue 130.

In other words, the dynamic scheduling mechanism 110B determines whether another execution unit 140 different from the execution unit 140 to execute the computational instruction held in the focused sub-instruction queue 130 will execute the computational instruction that uses the target data. The dynamic scheduling mechanism 110B performs step S136 if the other execution unit 140 will execute the computational instruction that uses the target data, and performs step S138 if the other execution unit 140 will not execute the computational instruction that uses the target data.

In step S136, the dynamic scheduling mechanism 110B exchanges instructions between the sub-instruction queues 130. That is, the dynamic scheduling mechanism 110B moves the computational instruction that uses the target data held in the focused sub-instruction queue 130 to the other sub-instruction queue 130, and moves another instruction held in the other sub-instruction queue 130 to the focused sub-instruction queue 130. With this, the computational instruction that uses the data in the same address range can be grouped into the sub-instruction queue 130 corresponding to the data buffer 150 to which the data in the same address range is transferred.

With this, multiple computational instructions that use the data in the same address range can be executed by one execution unit 140, and multiple computational instructions that use data in the same address range can be executed by using the data held in one data buffer 150.

After step S136, step S137 is performed. In step S137, the processor 100B causes one or more execution units 140 to execute the instruction and ends the operations illustrated in FIG. 7.

In step S138, the dynamic scheduling mechanism 110B waits for the transfer of the target data from the shared memory 160 to the data buffer 150 and ends the operations illustrated in FIG. 6. For example, if the computational instruction is not held in step S135, the dynamic scheduling mechanism 110B waits for the completion of execution of the data transfer instruction for transferring the target data used by the computational instruction from the shared memory 160 to the data buffer 150.

For example, if another processing is performed after exiting the loop processing in the program, the usage frequency of the computational instruction that uses the data included in the address range becomes less than the first frequency, and the computational instructions may be transferred to various sub-instruction queues 130 under the control of the scheduler 120B. In this case, the transfer of the same data from the memory 200 to multiple data buffers 150 can be suppressed by exchanging the instructions between the sub-instruction queues 130 and grouping and storing the computational instructions that use the data in the same address range in one sub-instruction queue 130. Additionally, the scheduler 120B can transfer the computational instruction to the sub-instruction queue 130 before an appropriate transfer destination is determined, thereby suppressing reduction in the transfer efficiency of the computational instruction from the scheduler 120B.

When the computational instruction is repeatedly executed using the data included in the same address range in the loop processing in the program, multiple computational instructions that use the data in the same address range can be held in one sub-instruction queue 130 without exchanging the instructions. This is realized by the processing in step S110 of FIG. 6. With this, the frequency with which computational instructions that use the data in the same address range are distributed and executed in the multiple execution units 140 can be reduced.

Here, as in the processor 100A of FIG. 3, the processor 100B may store, in the storage unit 111 of the dynamic scheduling mechanism 110B, the analysis result generated by the compiler 310 when the program is compiled. With this, the dynamic scheduling mechanism 110B can determine, using the analysis result, the sub-instruction queue 130 to which the computational instruction is transferred and the data buffer 150 into which the data is stored. As a result, the sub-instruction queue 130 to which the computational instruction is transferred and the data buffer 150 into which the data is stored can be appropriately determined from the start of the program execution.

As described above, in the embodiment illustrated in FIGS. 5 to 7, the effects substantially the same as those in the embodiments illustrated in FIGS. 1 to 4 can be obtained. For example, the transfer frequency of the data to be used by multiple computational instructions from the memory 200 to the data buffer 150 can be reduced. With this, the reusability of the data held in the data buffer 150 by the multiple computational instructions can be improved, thereby reducing the power consumption of the processor 100B.

Furthermore, in the embodiment illustrated in FIGS. 5 to 7, the dynamic scheduling mechanism 110B can exchange instructions between the sub-instruction queues 130. With this, multiple computational instructions that use the data in the same address range can be executed by one execution unit 140, and multiple computational instructions that use the data in the same address range can be executed by using the data held in one data buffer 150.

As a result, the transfer frequency of the data to be used by the multiple computational instructions from the memory 200 to the data buffer 150 can be reduced, thereby improving the reusability of the data held in the data buffer 150 by the multiple computational instructions. Additionally, the scheduler 120B can transfer the computational instruction to the sub-instruction queue 130 before an appropriate transfer destination is determined, thereby suppressing reduction in the transfer efficiency of the computational instructions from the scheduler 120B.

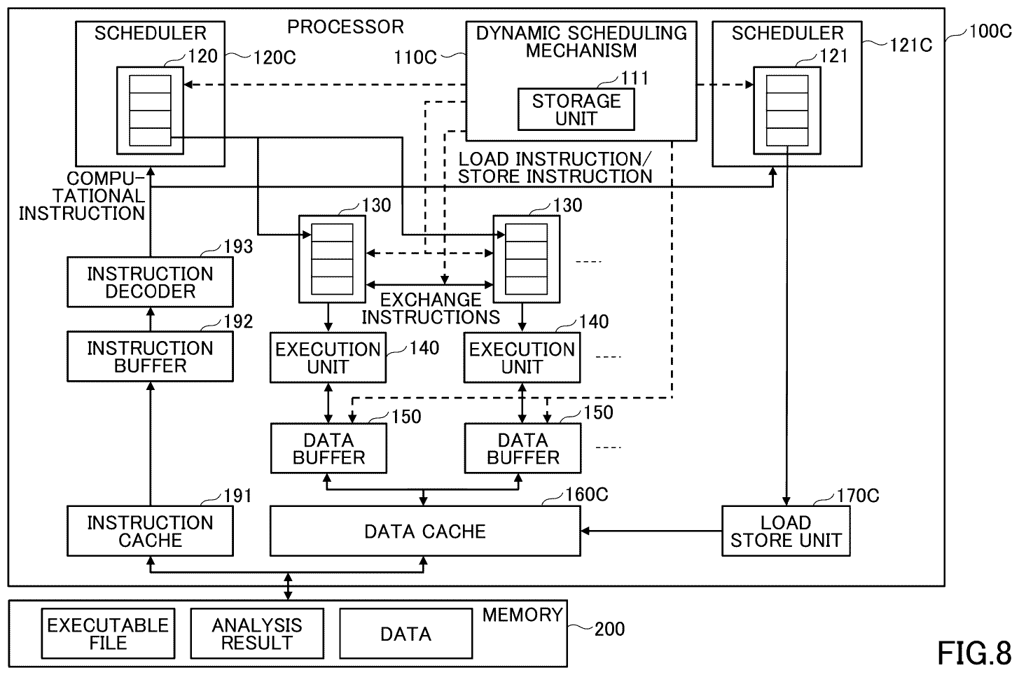

FIG. 8 illustrates an example of a processor in another embodiment. Elements substantially the same as those in FIGS. 1 and 5 are denoted by the same reference symbols and detailed description thereof is omitted. A processor 100C illustrated in FIG. 8 includes a dynamic scheduling mechanism 110C instead of the dynamic scheduling mechanism 110B in FIG. 5, and a scheduler 120C instead of the scheduler 120B in FIG. 5. The processor 100C includes a load-store unit 170C instead of the data transfer unit 170 in FIG. 5. The processor 100C includes a data cache 160C instead of the shared memory 160 in FIG. 5. For example, the processor 100C may be used for training or inference of image recognition in a neural network or the like, or may be used for scientific and technological calculations.

Additionally, the processor 100C includes an instruction cache 191, an instruction buffer 192, an instruction decoder 193, and a scheduler 121C for the data transfer instruction. As described, the processor 100C has the configuration and functions of a central processing unit (CPU). The other components of the processor 100C are substantially the same as those of the processor 100B illustrated in FIG. 5.

The dynamic scheduling mechanism 110C has a function of managing the scheduler 121C for the data transfer instruction, in addition to the function of the dynamic scheduling mechanism 110B illustrated in FIG. 5. The dynamic scheduling mechanism 110C is an example of the transfer control unit. For example, the dynamic scheduling mechanism 110C may have a function of adding transfer destination information indicating the data buffer 150 for storing data of a load instruction to the load instruction and adding transfer destination information indicating the data buffer 150 for reading data of a store instruction to the store instruction. The load instruction and the store instruction are examples of the data transfer instruction. Hereinafter, the load instruction and the store instruction are also referred to as the data transfer instructions.

If an instruction in an area indicated by a fetch address is held in an instruction holding area (cache hit), the instruction cache 191 reads the instruction from the instruction holding area and outputs it to the instruction buffer 192 without accessing the memory 200.

If the instruction in the area indicated by the fetch address is not held in the instruction holding area (cache miss), the instruction cache 191 reads the instruction included in the executable file held in the memory 200 and outputs it to the instruction buffer 192. Additionally, the instruction cache 191 stores the read instructions in the instruction holding area. Here, the instruction cache 191 reads instructions from the memory 200 in units of the cache line size of the instruction cache 191.

The instruction buffer 192 sequentially holds the instruction output from the instruction cache 191 and outputs the held instruction to the instruction decoder 193. The instruction decoder 193 sequentially decodes the instruction received from the instruction buffer 192, and if the decoded instruction is a computational instruction, stores the computational instruction in the main-instruction queue 120. If the decoded instruction is a load instruction or a store instruction, the instruction decoder 193 stores the load instruction or the store instruction in the instruction queue 121.

For example, the scheduler 120B may be a reservation station for computational instructions, and the scheduler 121C may be a reservation station for memory access. The scheduler 120C has substantially the same function as the scheduler 120B of FIG. 5 except that the scheduler 120C holds only computational instructions in the main-instruction queue 120 and transfers the held computational instruction to one of the sub-instruction queues 130.

The scheduler 121C includes an instruction queue 121 including multiple entries for holding the load instruction or the store instruction output from the instruction decoder 193. The scheduler 121C outputs the load instruction or the store instruction held in the instruction queue 121 to the load-store unit 170C in an executable order.

The load-store unit 170C outputs the load instruction or the store instruction from the instruction queue 121 to the data cache 160C and accesses the data cache 160C. The load-store unit 170C is an example of a data transfer unit.

If the data corresponding to the address included in the load instruction is held in the data holding area (cache hit), the data cache 160C reads the data from the data holding area and outputs it to the data buffer 150. The transfer destination information added to the load instruction by the dynamic scheduling mechanism 110C indicates which of the data buffers 150 to output the data to.

If the data corresponding to the address included in the load instruction is not held in the data holding area (cache miss), the data cache 160C reads the data from the memory 200, outputs it to the data buffer 150, and stores the read data in the data holding area.

If the data corresponding to the address included in the store instruction is held in the data holding area (cache hit), the data cache 160C stores the data output from the data buffer 150 in the data holding area. The transfer destination information added to the store instruction by the dynamic scheduling mechanism 110C indicates which of the data buffers 150 the data will be output from.

If the data corresponding to the address included in the store instruction is not held in the data holding area (cache miss), the data cache 160C performs read-access on the memory 200 by using the address included in the store instruction. After storing the data read from the memory 200 in the data holding area, the data cache 160° C. overwrites the data output from the data buffer 150 in the data holding area. Here, the data cache 160C reads and writes data from the memory 200 in units of the cache line size of the data cache 160C.

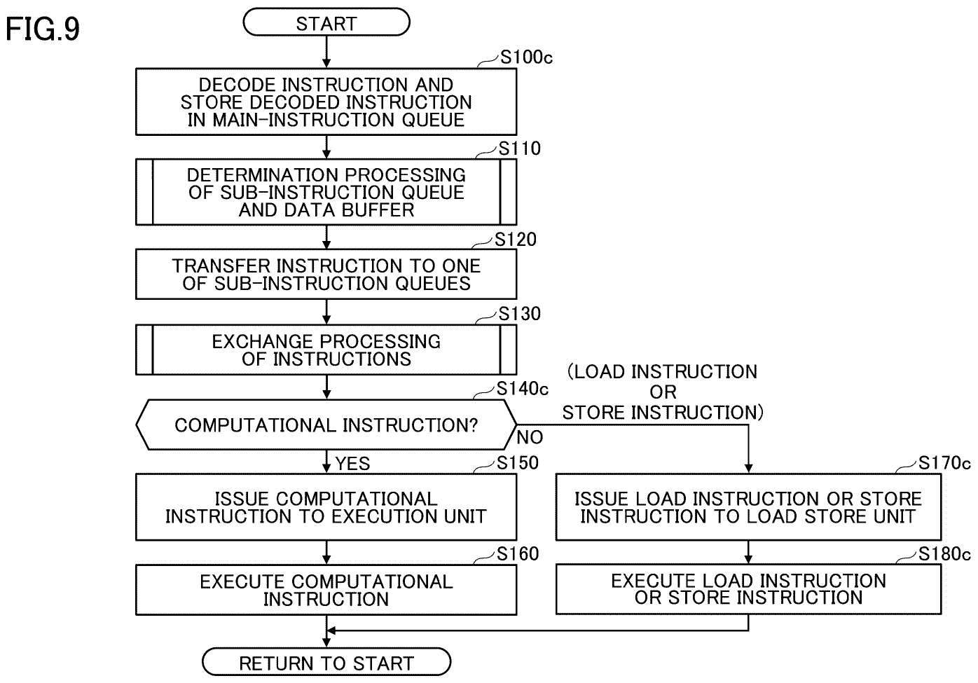

FIG. 9 illustrates an example of operations of the processor 100C illustrated in FIG. 8. That is, FIG. 9 illustrates an example of the operation control method of the processor 100C. Operations substantially the same as those in FIG. 6 are denoted by the same step numbers, and detailed description thereof is omitted. FIG. 9 is substantially the same as the operations in FIG. 6 except that S100c, S140c, S170c, and S180c are performed instead of $100, $140, S170, and $180 in FIG. 6.

First, in step S100c, the instruction decoder 193 decodes the instruction included in the executable file held in the memory 200 and stores it in the main-instruction queue 120. Subsequently, the processor 100C performs steps S110, S120, and S130 as in FIG. 6.

After step S130, in step S140c, the sub-instruction queue 130 determines whether the head entry holds a computational instruction. The sub-instruction queue 130 performs step S150 if the head entry holds a computational instruction, and performs step S170c if the head entry does not hold a computational instruction, that is, the head entry holds a load instruction or a store instruction. If the head entry holds a computational instruction, the sub-instruction queue 130 performs steps S150 and S160 as in FIG. 6.

In step S170c, the instruction queue 121 issues a load instruction or a store instruction to the load-store unit 170C. Next, in step S180c, the load-store unit 170C executes the load instruction or the store instruction. After the completion of steps S160 and S180c, the operations illustrated in FIG. 9 are repeatedly performed.

Here, as in the processor 100A in FIG. 3, the processor 100C may store the analysis result generated by the compiler 310 when compiling the program in the storage unit 111 of the dynamic scheduling mechanism 110C. With this, the dynamic scheduling mechanism 110C can determine, using the analysis result as well, the sub-instruction queue 130 to which the computational instruction is transferred and the data buffer 150 into which the data is stored. As a result, the sub-instruction queue 130 to which the computational instruction is transferred and the data buffer 150 into which the data is stored can be appropriately determined from the start of the program execution.

As described above, in the embodiment illustrated in FIGS. 8 and 9, the effects substantially the same as those in the embodiments illustrated in FIGS. 1 to 7 can be obtained. For example, the transfer frequency of the data used by multiple computational instructions from the memory 200 to the data buffer 150 can be reduced. With this, the reusability of the data held in the data buffer 150 by the multiple computational instructions can be improved, thereby reducing the power consumption of the processor 100C.

The dynamic scheduling mechanism 110C can exchange the instructions between the sub-instruction queues 130. With this, multiple computational instructions that use the data in the same address range can be executed by one execution unit 140, and multiple computational instructions that use the data in the same address range can be executed by using the data held in one data buffer 150.

As a result, the transfer frequency of the data used by the multiple computational instructions from the memory 200 to the data buffer 150 can be reduced, thereby improving the reusability of the data held in the data buffer 150 by the multiple computational instructions. Additionally, the scheduler 120C can transfer the computational instruction to the sub-instruction queue 130 before an appropriate transfer destination is determined, thereby suppressing reduction in the transfer efficiency of the computational instructions from the scheduler 120C.

With the above detailed description, the features and advantages of the embodiments are clear. It is intended that the scope of the claims extends to the features and advantages of the embodiments described above without departing from the spirit and scope of the claims. Any improvements and changes should be readily apparent to those who have ordinary knowledge in the art. Therefore, it is not intended to limit the scope of inventive embodiments to those described above, but may be based on suitable improvements and equivalents within the scope disclosed in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor comprising:
a plurality of execution circuits configured to execute a plurality of computational instructions;
a first instruction queue configured to hold the plurality of computational instructions;
a plurality of second instruction queues respectively provided corresponding to the plurality of execution circuits, the plurality of second instruction queues being configured to hold the plurality of computational instructions transferred from the first instruction queue, and issue the plurality of computational instructions held in the second instruction queues to the corresponding execution units;
a plurality of data buffers respectively provided corresponding to the plurality of execution circuits and configured to hold data to be used by the plurality of computational instructions; and
a transfer control circuit configured to detect an address of a memory that holds data to be used by each of the plurality of computational instructions held in the first instruction queue, transfer, to a second instruction queue corresponding to one of the plurality of execution circuits among the plurality of second instruction queues, target computational instructions that use data at a same address among the plurality of computational instructions, based on the detected address, and transfer the data at the same address to a data buffer corresponding to the one of the plurality of execution circuits among the plurality of data buffers.

2. The processor as claimed in claim 1, wherein the transfer control circuit transfers the target computational instructions that use high frequency data to the second instruction queue corresponding to the one of the plurality of execution circuits and transfers the high frequency data to the data buffer corresponding to the one of the plurality of execution circuits, the high frequency data being the data at the same address, and a frequency of the high frequency data used by the target computational instructions being greater than or equal to a first frequency.

3. The processor as claimed in claim 2, further comprising a scheduler configured to transfer an instruction held in the first instruction queue to one of the plurality of second instruction queues in an executable order,
wherein the scheduler transfers the plurality of computational instructions that use the high frequency data from the first instruction queue to the second instruction queue based on a notification from the transfer control circuit, and transfers the plurality of computational instructions that use low frequency data from the first instruction queue to one of the plurality of second instruction queues without receiving a notification from the transfer control unit.

4. The processor as claimed in claim 2, further comprising a data transfer circuit configured to transfer data from the memory to the plurality of data buffers based on data transfer instructions,
wherein the first instruction queue is configured to hold the data transfer instructions, and
wherein the transfer control circuit adds, to the data transfer instructions for transferring the data to be used by the plurality of computational instructions, transfer destination information indicating the plurality of data buffers to which the data is to be transferred.

5. The processor as claimed in claim 1, wherein the transfer control circuit groups the plurality of computational instructions that use the data at the same address held in two or more queues among the plurality of second instruction queues into the second instruction queue corresponding to the data buffer to which the data at the same address is to be transferred.

6. The processor as claimed in claim 5, wherein the transfer control circuit groups the plurality of computational instructions into the second instruction queue corresponding to the data buffer to which the data at the same address is to be transferred, by exchanging a first computational instruction held in one queue among the plurality of second instruction queues with a second computational instruction held in another queue among the plurality of second instruction queues.

7. The processor as claimed in claim 1, further comprising a storage unit configured to hold an analysis result including information on the data at the same address to be used by the plurality of computational instructions, the information being obtained by an analysis at a time of compilation of a program including instructions to be held in the first instruction queue,
wherein the transfer control circuit transfers the plurality of computational instructions from the first instruction queue to the second instruction queue and transfers the data from the memory to the plurality of data buffers, by using the analysis result held in the storage unit.

8. The processor as claimed in claim 1, wherein the transfer control circuit uses an address range from head data to tail data included in a data group transferred from the memory to one of the plurality of data buffers for each memory access request, as the same address.

9. An operation control method of a processor including:
a plurality of execution circuits configured to execute a plurality of computational instructions;
a first instruction queue configured to hold the plurality of computational instructions;
a plurality of second instruction queues respectively provided corresponding to the plurality of execution circuits, the plurality of second instruction queues being configured to hold the plurality of computational instructions transferred from the first instruction queue, and issue the plurality of computational instructions held in the second instruction queues to the corresponding execution units;
a plurality of data buffers respectively provided corresponding to the plurality of execution circuits and configured to hold data to be used by the plurality of computational instructions; and
a transfer control circuit, the operation control method comprising:
detecting, by the transfer control circuit, an address of a memory that holds data used by each of the plurality of computational instructions held in the first instruction queue, transfer, to a second instruction queue corresponding to one of the plurality of execution circuits among the plurality of second instruction queues, target computational instructions that use data at a same address among the plurality of computational instructions, based on the detected address; and
transferring, by the transfer control circuit, the data at the same address to a data buffer corresponding to the one of the plurality of execution circuits among the plurality of data buffers.
